(19) United States
(12) Patent Application Publication
(10) Pub. No.: US 2020/0034351 A1
(43) Pub. Date: Jan. 30, 2020

(54) Source Authentication And Changed Primitive Verification Systems And Methods For Real Time Updating Of Cloud-Based HD 3-D Map

(71) Applicants: DENSO International America, Inc., Southfield, MI (US); DENSO CORPORATION, Kariya-city (JP)

(72) Inventors: Kazuoki MATSUGATANI, Kariya-city (JP); Zhiyuan DU, West Bloomfield, MI (US); Joseph LULL, South Haven, MI (US); Rajesh MALHAN, Troy, MI (US)

(21) Appl. No.: 16/452,969

(22) Filed: Jun. 26, 2019

Related U.S. Application Data
(60) Provisional application No. 62/703,098, filed on Jul. 25, 2018.

(51) Int. Cl. G06F 16/23; G06K 9/00; G05D 1/00

(52) U.S. Cl. CPC G06F 16/2322; G06F 16/2358; G05D 1/0088; G06K 9/00805; G06F 16/2365

(57) ABSTRACT

Systems and methods are disclosed and include a node storing a local table and a control module that collects heterogeneous sensor data, tracks objects in an environment of the node, and converts the heterogeneous sensor data into time series data. An object-relational mapping module formats the time series data for direct compatibility to data in a master database of a cloud-based server. A correlation module further formats the time series data to provide resultant data in a single format commonly used by multiple map sources. A first primitive extraction module extracts primitives from the resultant data. An edge computing module generates a first table of data corresponding to the primitives and compatible with a master table of the master database, detects a changed primitive, uploads the changed primitive to the cloud-based server, receives updated data based on the changed primitive, and updates the local table based on the updated data.

### CROSS-REFERENCE TO RELATED APPLICATIONS

This application claims the benefit of U.S. Provisional Application No. 62/703,098, filed on Jul. 25, 2018. The entire disclosures of the applications referenced above are incorporated herein by reference.

### FIELD

The present disclosure relates to autonomous and/or assisted vehicle control systems and environment mapping systems.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Recent statistics have indicated that the number of fatalities in traffic accidents in the last 10 years is 1.2 million per year. Autonomous driving is expected to save millions of lives in the near future and thus is a leading focus point in the field of automotive research. Autonomous vehicle control and/or assisted vehicle control can be complex, especially in, for example, urban traffic situations and/or while driving on a highway.

A vehicle may be fully or partially autonomous and implement various autonomous and/or driver assisted applications (hereinafter referred to as “applications”). Some example applications are a lane change application, a collision avoidance application, a ramp routing application, and a platooning application. A lane change application may be executed to assist a driver of a vehicle and/or control vehicle operation during a lane change event, which includes moving a vehicle from a first lane of traffic to a second lane of traffic. A collision avoidance application may be executed to prevent a collision with a pedestrian, a vehicle and/or other object. A collision avoidance application may detect conditions of an environment and perform countermeasures to prevent a collision. This may include, for example, generating warning signals, assisting a driver of a vehicle in performing certain tasks (e.g., braking), and/or controlling operation of the vehicle.

A ramp routing application is similar to a lane change application and may be executed to assist a driver of a vehicle and/or control vehicle operation when moving a vehicle from a lane of traffic to an entrance ramp or an exit ramp. A platooning application may be executed to assist a driver of a vehicle during a platooning event. A platooning event refers to when one or more “follow” vehicles are controlled to closely follow one or more “lead” vehicles. A follow vehicle may also be a lead vehicle. Each follow vehicle may draft a lead vehicle. This is done to reduce drag on the follow vehicle for improved fuel efficiency and to reduce vehicle congestion within a given geographical area. Platooning that is implemented in a first geographical area can reduce congestion in other nearby geographical areas.

### SUMMARY

This section provides a general summary of the disclosure and is not a comprehensive disclosure of its full scope or all of its features.

A node is disclosed and includes a memory storing a local table and a control module configured to (i) collect heterogeneous sensor data, (ii) track objects in an environment of the node, and (iii) convert the heterogeneous sensor data into time series data. The node also includes an object-relational mapping module configured to format the time series data for direct compatibility to data in a master database of a cloud-based server. The node also includes a correlation module configured to further format the time series data to provide resultant data in a single format commonly used by multiple map sources. The node also includes a first primitive extraction module extract one or more primitives from the resultant data. The node also includes an edge computing module separate from the control module and configured to generate a first table of data corresponding to the one or more primitives and compatible with a master table of the master database, compare the first table to the local table to detect a changed primitive, upload the changed primitive and raw data corresponding to the changed primitive to the cloud-based server, and receive updated data based on the changed primitive from the cloud-based server and update the local table based on the updated data.

In some embodiments, the control module is configured to perform an assisted driving operation or an autonomous vehicle operation based on the updated data.

In some embodiments, the edge computing module is configured to extract a second primitive from the resultant data and the second primitive is at a higher level than the one or more primitives.

In some embodiments, the edge computing module is configured to generate the first table of data corresponding to the second primitive.

In some embodiments, the edge computing module is configured to perform an authorization process with the cloud-based server to authorize the node to upload the changed primitive and corresponding raw data to the cloud-based server.

In some embodiments, the edge computing module is configured to receive (i) a verification notice from the cloud-based server indicating whether the changed primitive and corresponding raw data has been verified with a plurality of other detected changed primitives and raw data provided to the cloud-based server from one or more sources other than the node, and (ii) the updated data from the cloud-based server and associated with the changed primitive.

In some embodiments, the edge computing module is configured to update the local table based on the updated data when the changed primitive is verified by the cloud-based server.

In some embodiments, the node is a vehicle and the control module controls a plurality of actuators of the vehicle based on the updated data.

In some embodiments, a system includes the node and the node is a first node. The cloud-based server comprises a changed primitive collection module configured to receive an update notification message from the edge computing module, wherein the update notification message indicates that the changed primitive has been detected, an authentication module configured to determine whether the first node is authorized to update map data, an object extraction and scene segmentation module configured to (i) receive the changed primitive and the raw data when the first node is authorized to update the map data, and (ii) perform object extraction and scene segmentation, a verification module configured to (i) correlate at least one of the changed primitive or the raw data with changed primitives and corresponding raw data of other nodes, and (ii) based on whether a plurality of nodes are reporting a same map segment change, verify the changed primitive of the first node is accurate, wherein the plurality of nodes include the first node and the other nodes, and a map update module configured to update the master database based on the changed primitive of the first node.

A cloud-based server is also disclosed and includes a memory configured to store a master database, a collection module configured to receive an update notification message from an edge computing module of a first node or an edge computing device separate from the first node, wherein the update notification message indicates a changed primitive has been detected, and wherein the changed primitive refers to an aspect of an environment of the node, an authentication module configured to determine whether the first node or the edge computing device is authorized to update map data, an object extraction and scene segmentation module configured to (i) receive the changed primitive and corresponding raw data when the first node or edge gateway device is authorized to update the map data, and (ii) perform object extraction and scene segmentation, a verification module configured to (i) correlate at least one of the changed primitive or the raw data with changed primitives and corresponding raw data of other nodes, and (ii) based on whether a plurality of nodes are reporting a same map segment change, verify the changed primitive of the first node or edge gateway device is accurate, wherein the plurality of nodes include the first node and the other nodes, and a map update module configured to update the master database based on the changed primitive of the first node or edge gateway device.

In some embodiments, the collection module is configured to receive the changed primitive and corresponding raw data from an edge computing module of the first node or the edge gateway device.

In some embodiments, the map update module is configured to generate updated data based on the changed primitive of the first node or edge gateway device and transmit the updated data to the first node to update a local database at the first node and as a result alter operation of the first node.

In some embodiments, the map update module is configured to generate updated data based on the changed primitive of the first node or edge gateway device and transmit the updated data to the edge gateway device to update a local database at the edge gateway device.

In some embodiments, the verification module is configured to (i) determine a number of map update notifications corresponding to the same map segment that have been received, and (ii) if the number of map update notifications is greater than or equal to a predetermined number, then verify the changed primitive of the first node or edge gateway device.

In some embodiments, the verification module is configured to (i) determine a number of map update notifications corresponding to the same map segment that have been received for a same date, and (ii) if the number of map update notifications is greater than or equal to a predetermined number for the same date, then verify the changed primitive of the first node or edge gateway device.

In some embodiments, the verification module is configured to (i) randomly select a predetermined number of the primitive changes for the same map segment; and (ii) correlate the randomly selected primitive changes for the same map segment with data in the master database to verify the changed primitive and check accuracy of the changed primitive.

An edge gateway device is also disclosed and includes a transceiver configured to receive one or more primitives from a node, wherein the one or more primitives refer to an aspect of an environment of the node, a memory configured to store a local table; and an edge computing module comprising a data compatibility module configured to generate a first table of data corresponding to the one or more primitives and compatible with a master table of a master database at a cloud-based server, a difference detection module configured to compare the first table to the local table to detect a changed primitive, an upload module configured to upload the changed primitive and raw data corresponding to the changed primitive to the cloud-based server, and a map update module configured to receive updated data based on the changed primitive from the cloud-based server and update the local table based on the updated data.

In some embodiments, the map update module is configured to transmit the updated data to the node to alter operation of the node based on the updated data.

In some embodiments, the edge computing module is configured to perform an authorization process with the cloud-based server to authorize the edge gateway device to upload the changed primitive and corresponding raw data to the cloud-based server.

In some embodiments, the edge computing module is configured to (i) receive a verification notice from the cloud-based server indicating whether the changed primitive and corresponding raw data has been verified with a plurality of other detected changed primitives and raw data provided to the cloud-based server from one or more sources other than the node, and (ii) receive the updated data from the cloud-based server and associated with the changed primitive, and (iii) update the local table based on the updated data when the changed primitive is verified by the cloud-based server.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle operating and environment mapping system including nodes, an edge gateway server and a cloud-based network in accordance with an embodiment of the present disclosure;

FIG. 2 is a perspective view of an example of a vehicle application enabling and network routing system in accordance with an embodiment of the present disclosure;

FIG. 3 a functional block diagram of an example of a node in accordance with an embodiment of the present disclosure;

FIG. 4 is a functional block diagram of an example of a vehicle in accordance with an embodiment of the present disclosure;

FIG. 5 is a functional block diagram of an example of an edge gateway server in accordance with an embodiment of the present disclosure;

FIG. 6 is a functional block diagram of an example of a cloud-based server in accordance with an embodiment of the present disclosure;

FIG. 7 illustrates a method of implementing assisted vehicle control and environment map updating in accordance with an embodiment of the present disclosure;

FIG. 8 illustrates an edge computing method for environment map updating in accordance with an embodiment of the present disclosure; and

FIG. 9 illustrates a cloud-based method for environment map updating in accordance with an embodiment of the present disclosure.

In the drawings, reference numbers may be reused to identify similar and/or identical elements.

### DETAILED DESCRIPTION

A high-definition (HD) three dimensional (3-D) map (or master map) is maintained for autonomous and assisted vehicle control. The HD 3-D map may be maintained and stored, for example, via a cloud-based server. In urban environments with high traffic density, the requirements for safe fully automated driving are numerous in terms of both vehicle specifications and infrastructure specifications. Environmental maps are used to help autonomous vehicles safely navigate in various environmental and traffic conditions. Environments are continuously changing and because of this the environmental maps may not be accurate and/or up-to-date.

The environmental maps may be stored in, for example, onboard vehicles, road side devices, local data centers, a cloud-based server and/or corresponding storage devices. Mapping is generally accomplished using specially equipped vehicles traversing highways and urban areas recording data and uploading the data to a processing center, where a master map of the environment is stored.

The processing center integrates the collected data into a map database. This process is resource intensive and may be conducted by the federal highway administration (FWHA). Accidents, construction and natural disasters can quickly change routes for vehicle travel. These changes occur quickly and can persist for days, weeks, or months while repairs are completed. The systems used for collecting and integrating the data stored in the map database are incapable of performing real-time updates and providing real-time responses associated with dynamic changes to the over 4 million of miles of public roads.

Advanced driver-assistance systems (ADAS) and autonomous driving (AD) vehicles are equipped, from the corresponding manufacturers, with unique sensors and configurations. The purpose of the sensor systems is to provide simultaneous location and mapping (SLAM) for quick vehicle path planning. Each unique system produces data that is inherently heterogeneous and thus not directly compatible.

The examples set forth herein includes the collecting and converting of the heterogeneous sensor data into a recognizable and compatible format that is able to be compared with other recognizable and compatible data from other vehicles. The examples include collecting time series data, combining the time series data for a particular aspect (e.g., a scene), extracting traffic and driving primitives. Examples of traffic and driving primitives, are lane markings, states of traffic lights, signs, lane shifts for new routes, road hazard detection for vehicle avoidance, road architecture detection for routing modifications, road and/or other locally detected construction, emergency traffic routing indications, detected objects, etc. Data tables that are comparable to data in a master map table/database are created for comparison with the master map table/database and detection of changes in an environment. Sources of the data tables are authenticated and the primitives and corresponding raw data for the changes is uploaded to a cloud-based server, where the data is verified prior to updating the master table/database and/or local table/map databases. By uploading data associated with changes and not all collected raw data, the amount of data uploaded and analyzed in the cloud-based server is greatly reduced. This allows for real time updates to be performed along with quick response times for autonomous vehicle operation.

The examples include updating and maintaining digital driving maps in real time and unifying and indexing data from various unique data sets into a common database. Raw heterogeneous data sets are provided in a time series format for fast processing and reduced data size for transmission to the cloud-based server. Heterogeneous infrastructure and traffic data for self-driving applications is auto-recognized, unified and indexed based on infrastructure and traffic primitives. Traffic primitives are identified for which changes have been detected and only these primitives and corresponding data segments are uploaded to the cloud-based server. This reduces data load on a communication network and corresponding network devices handling the uploaded data.

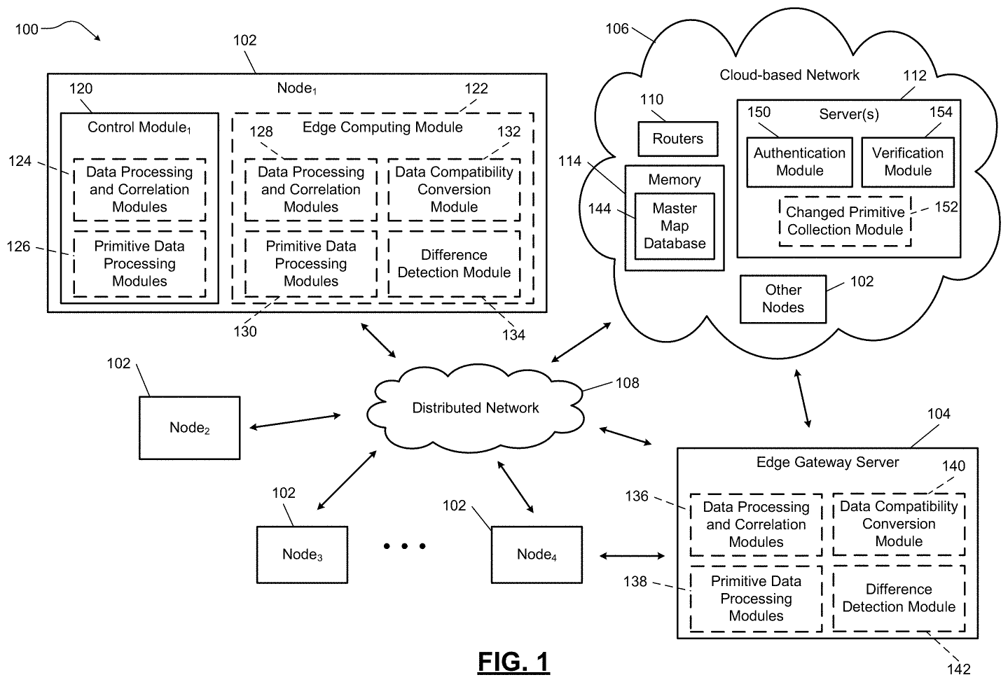

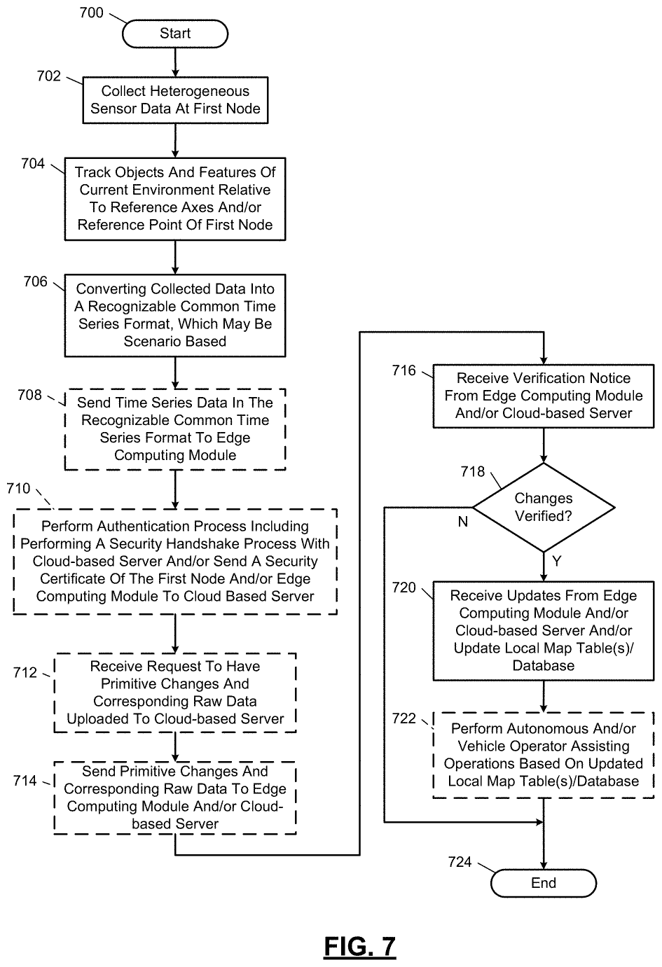

In the following FIGS. 1 and 3-6, various modules are shown with solid lines and dashed lines. The dashed lines indicate that in some embodiments, one or more of the corresponding modules is not included and/or is implemented in a different network device. Similarly, in FIGS. 7-9 certain operations are shown with dashed blocks. In some embodiments, one or more of these operations is skipped and/or not performed.

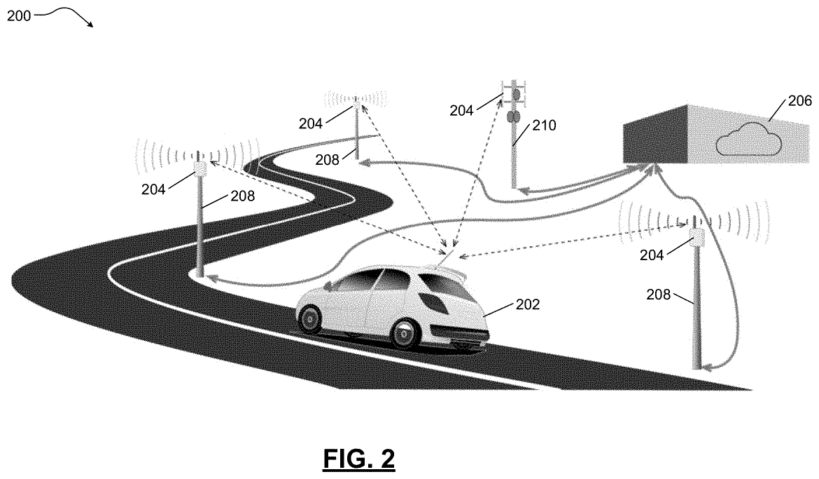

FIG. 1 shows an example of a vehicle operating and environment mapping system 100 that operates as a distributed edge computing system, which may span a geographical area (e.g., an office, a building, a neighborhood city, multiple cities, one or more states, and/or one or more countries). The vehicle operating and environmental mapping system 100 provides a distributed architecture, which may be implemented for a distributed environment similar to that shown in FIG. 2. The vehicle operating and environmental system 100 includes nodes 102, one or more edge gateway servers 104 and a cloud-based network (or “the cloud”) 106. One or more of the nodes may be located in the cloud-based network. As an example, the nodes 102 may communicate with each other directly or via a distributed network 108. The distributed network 108 may include the Internet, switches, routers, base stations, gateways, satellites, intermediary communication devices, etc. The cloud-based network 106 may include some of the nodes 102, routers 110, servers 112, memory 114 and/or other network devices. Although shown separately, one or more of the nodes 102 and the memory 114 of the cloud-based network 106 may be implemented as part of one or more of the servers 112.

Each of the nodes 102 may include a control module 120 for performing main operations of the node and an edge computing module 122 for performing edge computing operations and/or other onboard computing operations. The edge computing operations and/or other onboard computing operations include converting, analyzing, and uploading sensor data and receiving updated map data, as described in more detail below. One or more of the nodes 102 may not include the edge computing module 122. Each of the nodes 102 outside of the cloud-based network 106 may be a vehicle, a road side device (RSD), a local data center, or other network device. A RSD may be located at a signal light, on a building, on a pole near a road, or on some other structure. A RSD may monitor an environment in a local area of the RSD and/or share with other nodes information indicative of a state of the environment and/or other related information. One or more of the nodes 102 and/or the edge gateway server 104 may operate as an edge computing device performing various processing operations instead of the control modules of the nodes 102, which off loads (or “frees-up”) the control modules for performing other operations.

The information indicative of the state of the environment may include contextual parameters and information. Some examples of contextual parameters and information are: a number of vehicles connected to and utilizing network services within a given geographical area; an identification of the geographical area; a date; a day of the week; a time of day; whether it is a holiday; current weather conditions; whether a major event is occurring; vehicle traffic data; object data, etc.

The control module 120 may include data processing and correlation modules 124, primitive data processing modules 126 and other modules as described below. The edge computing module 122 may include data processing and correlation modules 128, primitive data processing modules 130, a data compatibility conversion module 132 and a difference detection module 134. The edge gateway server 104 may similarly include data processing and correlation modules 136, primitive data processing modules 138, a data compatibility conversion module 140 and a difference detection module 142.

The data processing and correlation modules 124, 128, 136 may collect heterogeneous sensor data, process the sensor data into a time series format and unify the sensor data into a single recognizable format. The primitive data processing modules 126, 130, 138 may extract primitives from the unified sensor data. The data compatibility conversion modules 132, 140 may convert extracted primitive data into one or more data tables compatible with map tables in a master map database 144. The master map database 144 may be stored in the memory 114. The difference detection modules 134, 142 may determine differences (referred to herein as “deltas”) between data of current primitives and previously stored map data.

The servers 112 of the cloud-based network 106 may include an authentication module 150, a change primitive collection module 152, and a verification module 154. The authentication module 150 authenticates sources of primitive data requested from the nodes 102 and/or the edge gateway server 104. The change primitive collection module 152 requests and collects from the nodes 102 and/or the edge gateway server 104 primitive data associated with changes in an environment. The verification module 154 verifies the collected primitive data and updates the master map database 144 when appropriate.

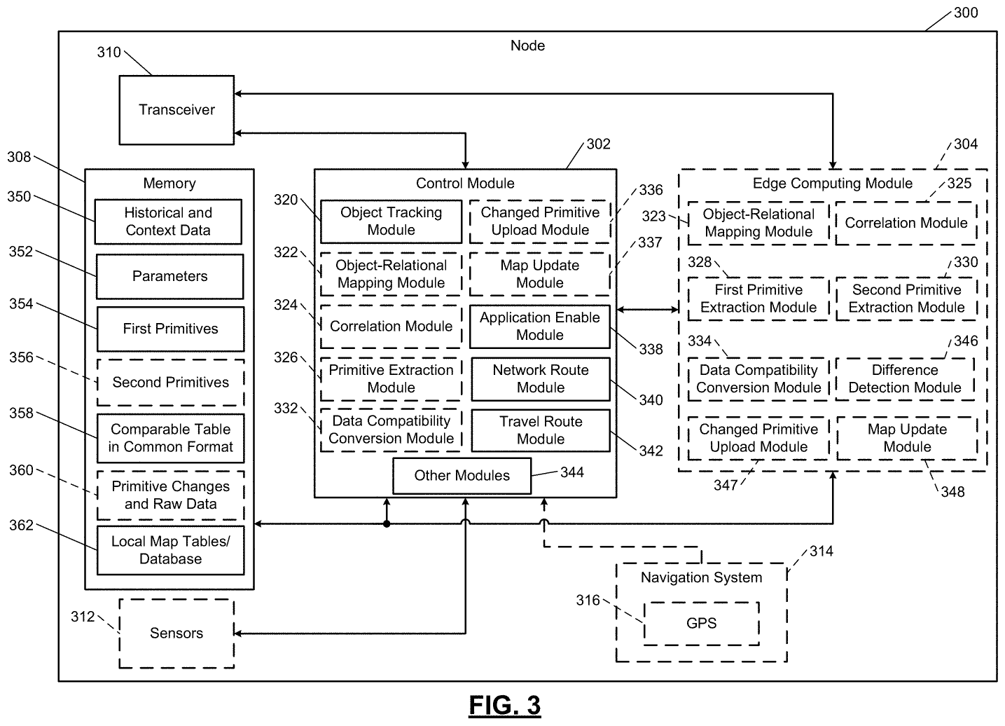

The modules of the nodes 102, the edge gateway server 104 and the cloud-based network 106 are further described below with respect to the example embodiments of FIGS. 3-9.

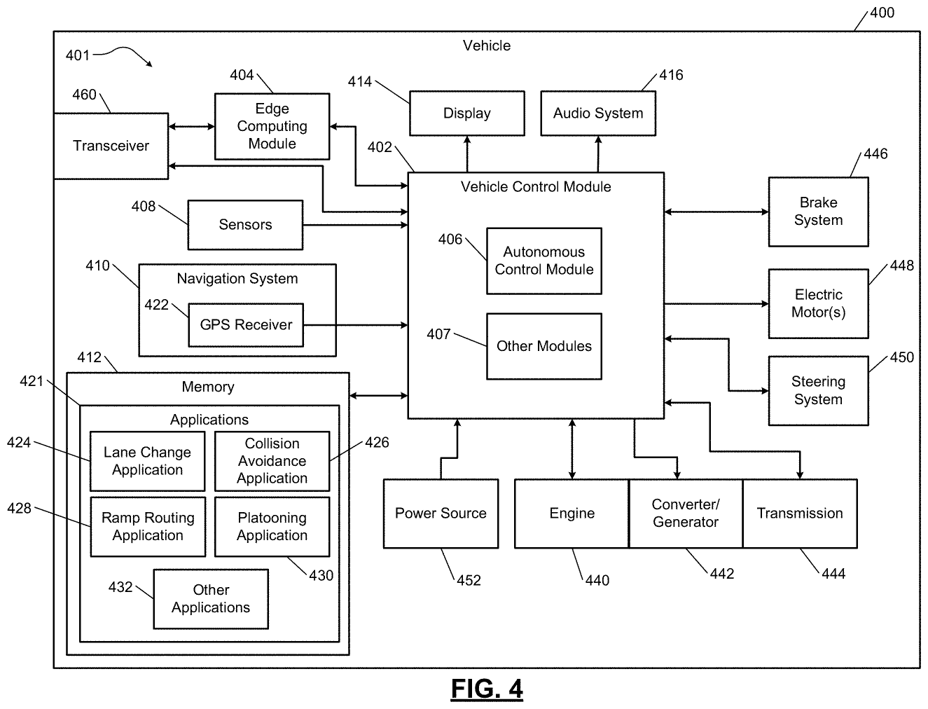

FIG. 2 shows a vehicle application enabling and network routing system 200 that includes a vehicle 202, RSDs 204, and a local data center or cloud-based server 206. The vehicle 202, the RSDs 204, and the local data center or cloud-based server 206 may be implemented as nodes 102 of FIG. 1 and/or as other nodes described herein. The RSDs 204 provide environment specific information for a location to the vehicle 202, whereas the local data center or cloud-based server 206 may provide local and/or non-local environment information to the vehicle 202. For example, one of the RSDs 204 may indicate to the vehicle environmental information in a local area of the RSD, such as indicate existence of pedestrians and/or other vehicles, provide signal light status updates, provide road conditions, etc. The local data center or cloud-based server 206 may provide environmental information associated with each geographical area of the RSDs 204 and/or the local data center or cloud-based server 206. A vehicle control module (an example vehicle control module is shown in FIG. 4) of the vehicle 202 may enable one or more applications based on the information received from the RSDs 204 and/or the local data center or cloud-based server 206.

The local data center or cloud-based server 206 may be implemented in the cloud-based network 106 of FIG. 1. The RSDs 204 may be implemented on poles 208 along a road, at a cell tower 210, or on some other structure. Each of the RSDs 204 may communicate and share information with any number of vehicles. The shared information may include data collected from one or more cameras and/or other sensors. The cameras and/or sensors may be located at the RSDs 204. Each RSD 204 may share information received from other RSDs, nodes and/or network devices. The cell tower 210 may provide network connectivity for the nodes and/or the local data center or cloud-based server 206. In one embodiment, the cell tower 210 is not implemented as a node in the vehicle application enabling and network routing system 200, but rather simply provides connectivity services.

FIG. 3 shows a node 300. The nodes of FIGS. 1-2 may be structured as the node 300. The node 300 may include a control module 302, an edge computing module 304, a memory 308, and a transceiver 310. The node 300 may also include sensors 312 and a navigation system 314. The sensors 312 may include cameras, objection detection sensors, Lidar sensors, radar sensors, an inertial measurement unit (IMU), temperature sensors, and/or other sensors that provide parameters and/or data associated with the state of the node 102 and/or an environment in which the node 102 is located. The navigation system 314 may include a global positioning system (GPS) 316, which provide location and/or other environmental data. The parameters and data may include context data. The stated parameters and data may be stored in the memory 308 as historical and context data 350 and parameters 352.

The control module 302 and the edge computing module 304 may include corresponding data processing and correlation modules such as an object tracking module 320, object-relational mapping (ORM) modules 322, 323, and correlation modules 324, 325. The control module 302 and the edge computing module 304 may include corresponding primitive data processing modules such as a primitive extraction module 326, a first primitive extraction module 328, and a second primitive extraction module 330. The primitive extraction modules 326, 328, 330 may store low level (or first) primitives 354 and high level (or second) primitives 356 in the memory 308. In one embodiment, the primitive extraction module 326 and the first primitive extraction module 328 extract low level primitives, whereas the second primitive extraction module 330 extracts high level primitives. The primitive extraction module 326 and the first primitive extraction module 328 may process time series data using a machine learning method (e.g., a Bayesian non-parametric method). The second primitive extraction module 330 may implement a deep neural network and/or cognitive computing methods to provide a higher level of primitive extraction as described below.

The control module 302 and the edge computing module 304 may include data compatibility conversion modules 332, 334. The data compatibility conversion modules 332, 334 may implement an application programming interface to compose data tables compatible (e.g., the comparable table 358 in a common format) with a map database format of one or more master map tables stored in a cloud-based server and/or corresponding memory. The control module 302 may further include a changed primitive upload module 336, a map update module 337, an application enable module 338, a network route module 340, a travel route module 342 and/or other modules 344. The edge computing module 304 may include a difference detection module 346, a changed primitive upload module 347 and a map update module 348. The change primitive upload module 336 upload primitive changes and corresponding raw data 360 to the edge gateway server 104, the servers 112 and/or other nodes and/or servers of FIG. 1. The edge computing module 304 may instruct the changed primitive upload module 336 to perform the upload based on primitive changes detected by the difference detection module 346. One or more of the map update modules 337, 348 may update and maintain one or more local map tables and/or database 362 based on updates received from, for example, the edge gateway server 104 and/or one or more servers and/or nodes of the cloud-based network 106. The local map tables and/or database 362 may include a HD 3-D map.

The application enable module 338 enables (or permits) and/or initiates execution of applications implemented within a vehicle. The network route module 340 selects a route for transmitting and receiving signals associated with an application. The travel route module 342 selects a travel route of a vehicle based on the historical environment data and/or other related information. Multiple possible travel routes may be determined by the navigation system 146. The travel route module 342 may select one of the possible travel routes. This may be true, for example, if the node 300 is a vehicle.

The modules of the node 300 are further described below with respect to the methods of FIGS. 7-9.

FIG. 4 shows a vehicle 400 that may include a vehicle system 401, which may be implemented as a vehicle mapping system, a vehicle application enabling system, a network routing system, and/or a travel routing selection system. The vehicle system 401 may include a vehicle control module 402 and an edge computing module 404. The vehicle control module 402 may include an autonomous control module 406 and/or other modules 407, such as the modules 302, 304, 320, 322, 324, 326, 332, 336, 338, 340, 342 and/or 344 of FIG. 3. The other modules 407 may also include other control modules, such as an engine control module, a transmission control module, and a motor control module. The edge computing module 404 may include the modules 323, 325, 328, 330, 334 and/or 346 of FIG. 3.

The vehicle 400 may further include sensors 408, a navigation system 410, a memory 412, a display 414 and an audio system 416. The sensors 408 may include cameras, objection detection sensors, temperature sensors, and/or other sensors that provide parameters and/or data associated with the state of the vehicle 400 and/or an environment in which the vehicle 400 is located. The parameters and data may include contextual data. The sensors 408 detect environmental conditions and status of vehicle devices. The navigation system 410 may include a GPS 422. The memory 412 may be similar to the memory 308 of FIG. 3 and store, historical data, context data, parameters, primitives, comparable tables, primitive changes and corresponding raw data, local map tables and/or database, as well as applications 421. The applications 421 may include a lane change application 424, a collision avoidance application 426, a ramp routing application 428, a platooning application 430, and/or other applications 432.

The vehicle control module 402 may execute the applications 421 and may control operation of an engine 440, a converter/generator 442, a transmission 444, a brake system 446, electric motors 448 and/or a steering system 450 according to parameters, data, values, commands, etc. determined, calculated, estimated, predicted, and/or generated as a result of executing the applications 421. The vehicle control module 402 may receive power from a power source 452 which may be provided to the engine 440, the converter/generator 442, the transmission 444, the brake system 446, the electric motor(s) 448, the steering system 450, etc. The autonomous control module 406 may control operation of the engine 440, the converter/generator 442, the transmission 444, a brake system 446, one or more electric motor(s) 448, and steering system 450. The vehicle control module 402 may generate output signals including warning, alert and/or status signals via the display 414, and/or the audio system 416. As an example, warning signals may be generated when objects are detected to avoid a collision.

The vehicle control module 402 may be in communication with the edge computing module 404 as shown. The vehicle 400 may further include a transceiver 460 via which the vehicle control module 402 and the edge computing module 404 may communicate with other network devices, such as the edge gateway server 104 and devices in the cloud-based network 106 and the distributed network 108 of FIG. 1. The vehicle control module 402 may control operation of the engine 440, the converter/generator 442, the transmission 444, the brake system 446, the electric motors 448 and/or the steering system 450 based on outputs of the edge computing module 404 and/or outputs from one or more of the other modules 407.

The engine 440, the converter/generator 442, the transmission 444, the brake system 446 the electric motor(s) 448, and the steering system 450 may include actuators controlled by the vehicle control module 402 to, for example, adjust fuel, spark, air flow, throttle position, pedal position, steering wheel position, etc. This control may be based on the outputs of the sensors 408, the navigation system 410, and the GPS receiver 422.

One of the other modules 407 may perform countermeasures to avoid an accident by controlling at least some operations of the vehicle 400. This may include limiting speed of the vehicle, reducing speed of the vehicle, maintaining predetermined distances from objects, changing a lane, changing a direction of travel of the vehicle, generating alert/warning signals, etc.

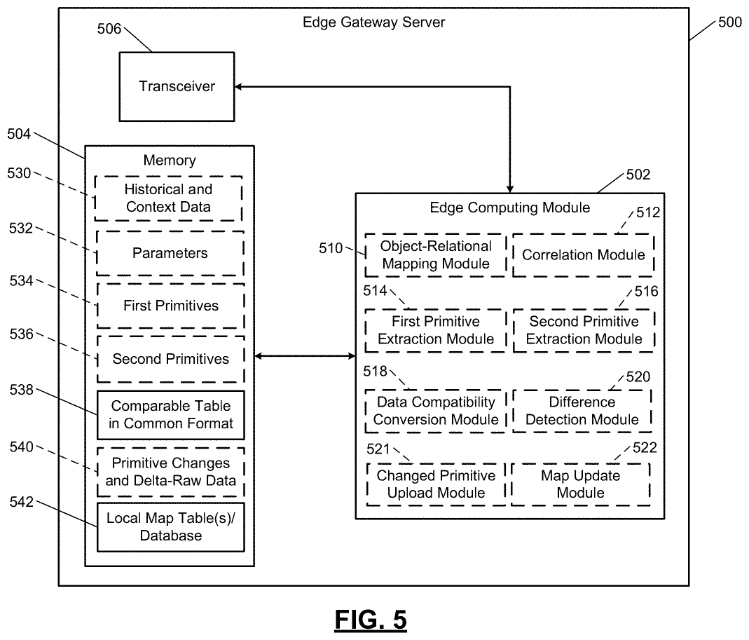

FIG. 5 shows an example of the edge gateway server 104 of FIG. 1 identified as edge gateway server 500. The edge gateway server 500 includes an edge computing module 502, a memory 504 and a transceiver 506. The edge computing module 502 may communicate with the nodes 12 and devices in the cloud-based network 105 and the distributed network 108 of FIG. 1 via the transceiver 506. The edge gateway server 500 and/or one or more of the nodes 102 of FIG. 1 may be part of a fog network and perform computations, storage and local communication and route data processing and/or analyzing results to the cloud-based servers 112. The memory 504 may be a fog networking storage device.

The edge computing module 502 may include: data processing and correlation modules, such as an ORM module 510 and a correlation module 512; primitive data processing modules, such as a first primitive extraction module 514 and a second primitive extraction module 516; a data compatibility conversion module 518; a difference detection module 520; a changed primitive upload module 521, and a map update module 522. The memory 504 may store historical and context data 530, parameters 532, first primitives 534, second primitives 536, a comparable table 538 in a common format, primitive changes and corresponding raw data 540, and one or more local map tables and/or database 542. The modules 510, 512, 514, 516, 518, 520, 521 may operate similarly as the modules 323, 325, 328, 330, 334, 346, 347 of FIG. 3. The edge computing module 502 may receive, transmit, and/or share vehicle and environmental related data, parameters, primitives, tables, etc. with the nodes 102 and servers 112 of FIG. 1. The map update module 522 updates the one or more local map tables and/or database 542. The local map tables and/or database 542 may include local map tables for one or more nodes and include data indicative of states and/or locations of the one or more nodes and states of local environments of the one or more nodes. The local map tables and/or database 542 may include one or more HD 3-D maps.

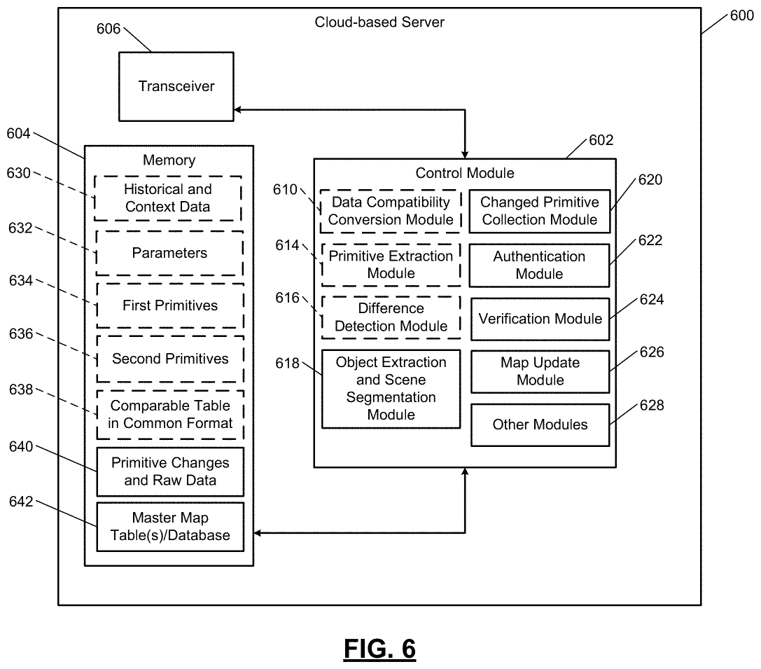

FIG. 6 shows an example of one of the servers 112 of FIG. 1 identified as cloud-based server 600. The cloud-based server 600 may include a control module 602, a memory 604, and a transceiver 606. The control module 602 may communicate with the nodes 12 and edge gateway server 104 and the distributed network 108 of FIG. 1 via the transceiver 606. The control module 602 may include a data compatibility conversion module 610, a primitive extraction module 614, a difference detection module 616, an object extraction and scene segmentation module 618, a changed primitive collection module 620, an authentication module 622, a verification module 624, a map update module 626 and other modules 628. The memory 604 may store historical and context data 630, parameters 632, first primitives 634, second primitives 636, a comparable table 638 in a common format, primitive changes and corresponding raw data 640, and one or more master map tables and/or database 642. The modules 610, 614, 616 may operate similarly as the modules 334, 330, 346 of FIG. 3. Operations of the modules 610, 614, 616, 618, 620, 622, 624, 626, 628 are described in more detail below with respect to the methods of FIGS. 7-9. The master map database 642 is an example of the master map database 144 of FIG. 1 and may include a HD 3-D map.

The control module 602 may receive, transmit, and/or share vehicle and environmental related data, parameters, primitives, tables, etc. with the nodes 102 and edge gateway server 104 of FIG. 1. The map update module 626 updates the one or more master map tables and/or database 642. Each of the master map tables may include a combination of multiple different local map tables for nodes in different locations.

The systems disclosed herein may be operated using numerous methods, an example method is illustrated in FIGS. 7-9. The methods of FIGS. 7-9 may be performed as a single method. The methods are provided as examples. Although certain operations are described as being performed by a control module of a node, an edge computing module of a node, an edge computing device, an edge gateway server, and a node or server in a cloud-based network, the operations may be performed by one or more of the other nodes, modules, and/or servers disclosed herein. For example, certain operations may be performed by a vehicle control module or an edge computing module in a vehicle. As another example, certain operations may be performed by the edge computing module of the vehicle or an edge computing module in another node or in an edge gateway server. As yet another example, certain operations may be performed in an edge computing module of: a vehicle; a node; an edge computing device; an edge gateway server; and/or a node or server in a cloud-based network.

In FIG. 7, an example method of implementing assisted vehicle control and environment map updating is shown. Although the following operations of the following methods are primarily described with respect to the implementations of FIGS. 1-6, the operations may be easily modified to apply to other implementations of the present disclosure. The operations may be iteratively performed.

The method may begin at 700. At 702, the object tracking module 320 collects heterogeneous sensor data (or raw data) at a first node (e.g., a vehicle). The sensor data indicates states of the first node, conditions within the first node, and state of the environment surrounding the first node. This may include detecting surrounding objects and determining locations, speeds, and traveling paths of the objects relative to the first node. At 704, the object tracking module 320 tracks objects and features of the current environment relative to references axes and/or a reference point of the first node. The objects may include animate and inanimate objects, vehicles, buildings, roads, signs, traffic signals, lane markings, etc. All objects are tracked relative to a common set of axes and/or one or more reference points. This relates the sensor data in space and time.

At 706, the object tracking module 320 converts the collected sensor data into a recognizable format, which may be scenario based. This includes converting the collected sensor data into a recognizable common time series format to provide time series data. At 708, object tracking module 320 may send the time series data to an edge computing module (e.g., the edge computing module 304, the edge computing module of another node, or the edge computing module 502). Operation 802 may be performed subsequent to operation 708.

At 710, the edge computing module of the first node may perform an authorization process including performing a security handshake process with the cloud-based server. This may include exchanging security information. The edge computing module may send a security certificate to the cloud-based server. The security certificate may include security information such as public and private keys, a unique signature, an identifier of the first node, a source address, a destination address, and/or other security information. See operation 904 below.

At 712, the changed primitive upload module 336 receives a request message to have primitive changes of one or more primitives and the corresponding raw data uploaded to the cloud-based server. At 714, the changed primitive upload module 336 transmits the primitive changes along with the corresponding raw data to the cloud-based server. In one embodiment, when one or more primitive changes have been detected, only the raw data corresponding to the one or more primitive changes (i.e. defining one or more changes in one or more primitives) is sent. Raw data associated with other unchanged primitives is not sent.

At 716, the changed primitive upload module 336 receives a verification notice from the edge computing module of an edge computing device (e.g., a second node including an edge computing module or the edge gateway server) and/or the cloud-based server. The verification notice indicates whether the primitive changes are verified.

At 718, the changed primitive upload module 336 determines whether the primitive changes have been verified. If verified, then operation 720 is performed, otherwise the method may end at 724.

At 720, the map update module 337 receives updates from the edge computing module and/or the cloud-based server and/or updates the local map table(s) and/or database 362 of the first node. The updates may be based on updates received from the edge computing module and/or cloud-based server and correspond to the primitive changes.

At 722, the application enable module 338, the autonomous control module 406 and/or other module of the first node may perform one or more operations based on the updated local map table(s) and/or database 362. As a couple of examples, this may include performing one or more driver assistance and/or autonomous vehicle operations based on the updated information in the local map table(s) and/or database 362. For example, alerts signals may be generated if an impending object is approaching and/or actuators of the corresponding vehicle may be controlled to decelerate, accelerate, and/or steer the vehicle. These operations may be performed to slow down, speed up, maintain a lane of traffic, change traffic lanes, turn the vehicle and/or perform some other behavior and/or combinations of behaviors. The method may end at 724 subsequent to performing one of operations 718, 720, 722.

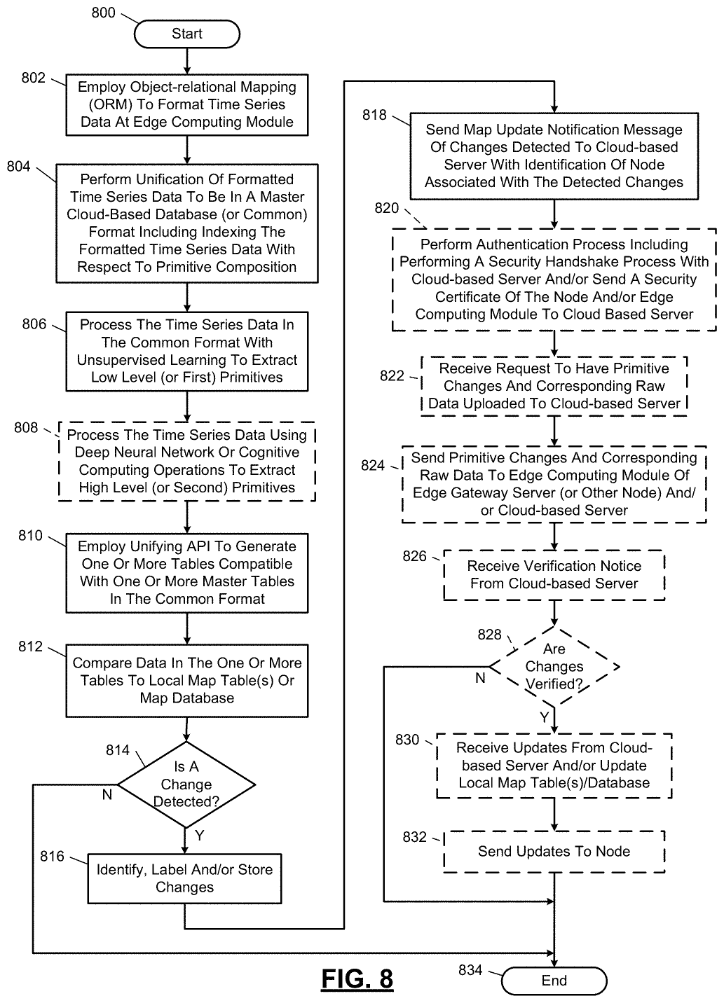

FIG. 8 shows an edge computing method for environment map updating. The operations may be iteratively performed. In one embodiment, the operations of FIG. 8 are performed by an edge computing module, such as one of the edge computing modules of the nodes 102, an edge computing device, and the edge gateway server 104. In another embodiment, one or more of the operations is performed by a control module of one of the nodes 102 and/or one of the servers 112.

The method may begin at 800. At 802, an ORM module (e.g., one of ORM modules 322, 323, 510) implements ORM to form the time series data for direct compatibility with the master map database 144 or 642. This may include arranging raw multi-dimensional driving data into time series. Although the data format and frequency vary among datasets, the data sets include timestamps. This allows the ORM module to unpack, reorder, and convert data set files to time series.

At 804, a correlation module (e.g., one of modules 323, 324, 510) performs intermediate processing to correlate the time series data to be in a single database format to allow a common map source, such as the cloud-based server 112 or 600, having a broader knowledge base to unify various unique time series from multiple nodes (or map sources). This provides a unification framework. The correlation module may store the time series data into one or more tables, where each table corresponds to one kind of sensor, one object, one environmental feature, etc. The correlation module may provide a relational structure by relating the time series data using an indexing process to allow for quick and easy querying and maintaining of unified and indexed data. The time series data may be processed using a machine learning method (e.g., a non-parametric Bayesian method) to create a unifying indices (or labels) for the time series data. The machine learning method may include segmenting and classifying the time series data according to characteristics.

At 806, a first primitive extraction module (e.g., one of the modules 326, 328, 514) may process the time series data using a machine learning method (e.g., a non-parametric Bayesian method) with unsupervised learning to extract low level (or first) primitives. This may include extract highway primitives and scene data. This may include dividing the time series data into segmentations, referred to as primitives. The primitives may be clustered and classified according to statistical similarities of the primitives. Extraction of the low level primitives may include non-parametric phase signal mapping, hidden Markov mapping, or other similar methods of unsupervised learning.

Driving or traffic primitives may be treated as a representation of fundamental building blocks of driving encounters. Each driving encounter may be segmented into a finite number of primitives with distinct attributes. Each driving primitive may describe and/or define an aspect of an environment, such as a location of an object, a vehicle traveling in a certain direction and speed, state and location of a traffic sign and/or signal, etc. Each driving primitive may not have temporal overlap with others. An example mathematical formulation of a driving primitive Y̅ is represented by equation 1, where Y is a driving encounter, y refers to positions of one or more nodes at time t and velocities of the one or more nodes at time t, T is a length of data samples of the driving encounter Y, m and n are periods of time, Y̅⊂Y with m≤n≤T.

Y̅={yₘ, . . . ,yₙ} (1)

The data within [yₘ, yₙ] is treated as the samples for the primitive Y̅. Theoretically, a length of a driving primitive of a single driving encounter may be (n−m+1)∈[1, T].

At 808, the first primitive extraction module or a second primitive extraction module (e.g., one of the modules 330, 516, 614) may implement a deep neural network or cognitive computing methods to extract high level (or second) primitives depending the capabilities of a corresponding processor (e.g., processing speeds and memory of the processor). The processing performed to extract the high level primitives may be more precise and utilize convolutional neural networks to define scenes using semantics (e.g., identify speed zones, medians, fencing, corners, centers of lanes, lane stripping, edges of road and medians, etc.). This is referred to as multi-layer mapping, where each of these items is associated with a particular layer of the map.

At 810, a data compatibility conversion module (e.g., one of the modules 332, 334, 518, 610) implements a unifying application programming interface (API) to generate one or more tables in a common format that is compatible with the one or more master tables. As an example, the one or more tables may be in a structured query language (SQL) database table format. This may be referred to as a unification operation and may include investigating statistical properties of primitives and/or primitive sets and real world meaning of time series data. The primitives (first and/or second primitives) are filtered according to duration, distribution and appearance frequency. Subsequently, the scenarios and/or combinations of the primitives may be labeled using primitive indices. A whole data set may be identified by an index of a combination of primitives. This allows reorganizing time series data according to real-world scenarios.

At 812, a difference detection module (e.g., one of the modules 346, 520, 616) compares the data in the one or more tables created at 810 with one or more local map tables and/or map database (e.g., the tables and databases 362, 542, 642). This may be a change in state of a parameter of a node, a change in a state and/or aspect of a local environment, etc. The comparisons may include comparing primitives and/or corresponding time series data. In one embodiment, the difference detection module monitors one or more signals including the time series data for perturbations in waveforms and tags the perturbations to identify the detected differences.

At 814, if a change is detected, operation 816 is performed and the detected differences are identified, labeled (or indexed), annotated, and/or stored as new primitive changes of one or more primitives in memory (e.g., one of the memories 308, 504, 604). The raw data associated with the differences may be collected and stored along with the associated primitive as part of a data package in the memory. The data package may also be labeled. Identification information for the data packages generated may be stored in a look-up table in the memory and used when transferring the data packages to, for example, a cloud-based server (e.g., one of the servers 112) for processing, as described below. If no differences are detected, then the method may end at 834.

At 818, the difference detection module may send a map update notification message to the cloud-based server indicating that changes have been detected. The update notification message may include an identifier of the first node that detected the changes and/or a security certificate of the first node. Operation 902 is performed subsequent to operation 818. Operation 710 and/or operation 820 may also be performed subsequent to operation 818.

At 820, the edge computing module of the edge gateway server may perform an authorization process including performing a security handshake process with the cloud-based server. This may include exchanging security information. The edge computing module may send a security certificate to the cloud-based server. See operation 904 below.

At 822, the edge computing module of the first node and/or edge computing device may receive a request message from the cloud-based server to have primitive changes and corresponding raw data uploaded to the cloud-based server. At 824, the changed primitive upload module (e.g., one of the changed primitive upload module 347, 521) may send primitive changes and corresponding raw data to the edge computing module of edge gateway device and/or cloud-based server. If sent to the edge computing module of the edge computing device, the edge computing device may then forward the primitive changes and corresponding raw data to the cloud-based server.

At 826, the changed primitive upload module receives a verification notice from the edge computing module of the edge computing device and/or the cloud-based server. The verification notice indicates whether the primitive changes are verified.

At 828, the changed primitive upload module determines whether the primitive changes have been verified. If verified, then operation 830 is performed, otherwise the method may end at 834.

At 830, the map update module 348 receives updates from the edge computing module of the edge computing device and/or the cloud-based server. The map update module 348 may update the local map table(s) and/or database of the edge computing device. The updates may be based on updates received from the edge computing device and/or cloud-based server and correspond to the changed primitives. At 832, the map update module 348 may send the updates to the edge computing module of the first node. The method may end at 834 subsequent to performing operation 832.

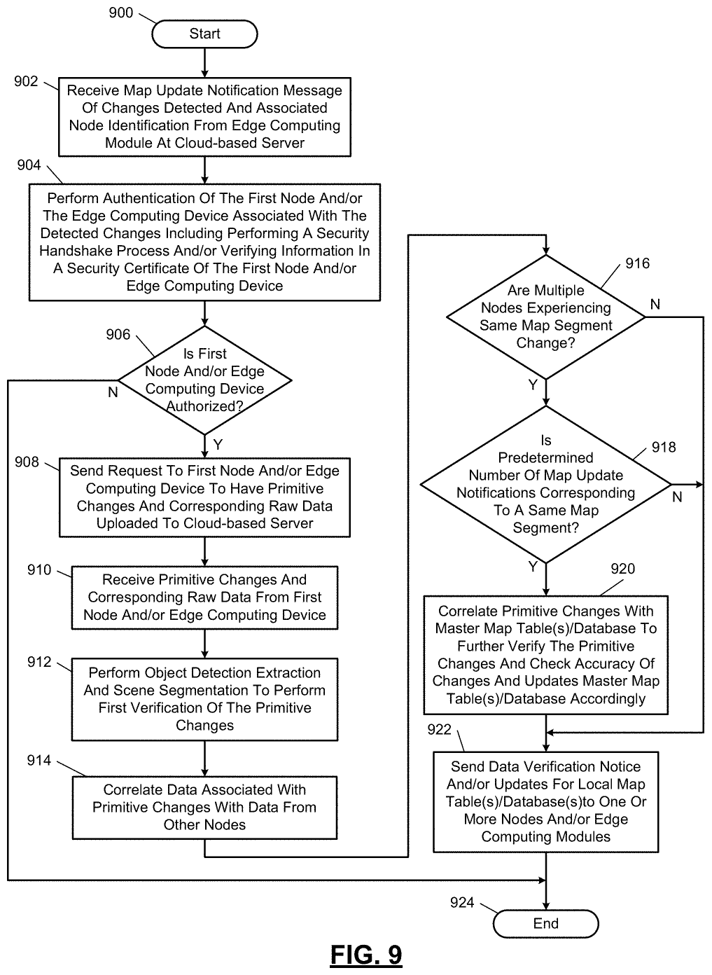

FIG. 9 shows a cloud-based method for environment map updating. The operations may be iteratively performed. The method may begin at 900. At 902, the control module 602 receives the map update notification message indicating the primitive changes detected from (i) the edge computing module of the first node that detected the primitive changes, or (ii) the edge computing device. At 904, the authentication module 622 performs an authentication process with the edge computing module of the first node and/or the edge computing module of the edge computing device to authenticate a contributing source (e.g., the node) of primitive changes. This may include performing a handshake process and/or verifying information in the security certificate. The authentication module may for example verify one or more identifiers of the first node and/or edge computing device, one or more public keys, one or more private keys, a signature of the certificate, source and/or destination addresses, a vehicle identifier, and/or other security information. The handshake process may include the exchanging of information including the security information between the authorization module 622 and the edge computing module of the first node and/or the edge computing module of the edge computing device.

At 906, the authentication module 622 determines whether the first node and/or edge computing device that detected and/or is associated with the primitive changes is an authorized network device. If authorized, operation 908 is performed subsequent to operation 906, otherwise the method may end at 924.

At 908, the authorization module 622 and/or the map update module 626 sends request message to the first node and/or the edge computing device to have primitive changes and the corresponding raw data associated with the changes uploaded to the cloud-based server. In one embodiment, when one or more primitive changes have been detected, only the raw data corresponding to the one or more primitive changes is uploaded. This minimizes the amount of data being uploaded.

At 910, the changed primitive collection module 620 receives primitive changes and corresponding raw data from the first node and/or edge computing device. This may be via the edge computing module of the first node and/or the edge computing module of the edge computing device.

At 912, the object extraction and scene segmentation module 618 performs object detection extraction and scene segmentation in preparation to verification of primitive changes. This may be referred to as a first verification and may include comparing detected objects and scene segmentation data associated with the primitive changes with scene segmentation of corresponding data in the master map table(s) and/or database 642. The first verification may be performed to confirm that primitive changes have occurred.

At 914, the verification module 624 correlates data associated with the primitive changes with data from other nodes. The first node and the other nodes may have received heterogeneous sensor data in various formats, such as png, txt, xml, mat, ppm, log, peap, jpg, log, csv, ROSBAG, json, SQL, image, video, etc. and have converted the data in these formats to time series compatible data format as similarly described above with respect to the first node. The first node and the other nodes may have detected same or similar primitive changes based on corresponding time series data provided in the same compatible data format, which is correlated by the verification module 624.

At 916, the verification module 624 determines whether multiple nodes are experiencing the same map segment change based on the correlated data of the primitive changes of multiple nodes. If multiple nodes including the first node are experiencing the same map segment change, operation 918 is performed, otherwise operation 922 may be performed. Operations 914 and 916 include harmonizing and comparing map input from multiple data sources.

At 918, the verification module 624 determines whether a predetermined number (e.g., 5-7) of map update notifications corresponding to a same map segment exist. This may be determined for a same date and/or a same or similar time of day. If the number of map update notifications for a same map segment that exist is greater than or equal to the predetermined number, then operation 920 is performed, otherwise operation 922 may be performed.

At 920, the map update module 626: randomly selects a predetermined number (e.g., 5-7) of the primitive changes for the same map segment; and correlates the randomly selected primitive changes for the same map segment with master map table(s) and/or database 642 to further verify the changes and check accuracy of the changes; and updates the master map table(s) and/or database 642 accordingly. This may be referred to as a second verification.

At 922, the verification module 624 and/or map update module 626 sends data a verification notice and/or updates for local map table(s) and/or database(s) to one or more nodes and/or edge computing modules. The method may end at 924 subsequent to performing operation 922.

The above-described operations of FIGS. 7-9 are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-described examples utilize edge computing or similar onboard computing techniques coupled with implementing an automated highway and map primitives extraction process to take raw sensor data at a vehicle level and produce highway and map primitives in real time. The primitives are uploaded directly to a map center (or cloud-based server) for correlation and map updates. This reduces data set sizes, data segments and/or blocks being uploaded and/or updated and thus reduces data load of a cloud-based network and provides near real time map updates. This also may reduce the amount of updated data downloaded from the cloud-based server to a node. Since less data is uploaded, updated and downloaded, bandwidth requirements are minimized and reduced as compared to traditional map update systems. The amount of time (referred to herein as real time map updates) for preprocessing sensor data, uploading primitive data, processing the primitive data, performing authentication and verification, and updating master and local map tables and databases may be on the order of a few hundred milli-seconds or less. Similarly, the performing of operations to detect primitive changes, the transmission of the primitive changes and corresponding raw data from a node to a cloud-based network server, and the response time for the cloud-based network server to send updated data may be on the order of a few hundred milli-seconds or less.

The raw heterogeneous sensor data is processed in real time on vehicles to update map data. The second data is converted to time series and primitives are then extracted. Primitives are compared to an onboard map. When a change is detected, only the new primitive data and corresponding raw sensor data is uploaded to a cloud-based server for master map database updating purposes. If the detected change is verified as being accurate, then the new primitive data is processed and/or entered into the master map database. This may include replacing previously entered primitive data with updated primitive data. The above-described examples are accomplished without slowing down and/or shutting down mission-critical systems.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A node comprising:
a memory storing a local table;
a control module configured to (i) collect heterogeneous sensor data, (ii) track objects in an environment of the node, and (iii) convert the heterogeneous sensor data into time series data;
an object-relational mapping module configured to format the time series data for direct compatibility to data in a master database of a cloud-based server;
a correlation module configured to further format the time series data to provide resultant data in a single format commonly used by multiple map sources;
a first primitive extraction module extract one or more primitives from the resultant data; and
an edge computing module separate from the control module and configured to
generate a first table of data corresponding to the one or more primitives and compatible with a master table of the master database,
compare the first table to the local table to detect a changed primitive,
upload the changed primitive and raw data corresponding to the changed primitive to the cloud-based server, and
receive updated data based on the changed primitive from the cloud-based server and update the local table based on the updated data.

2. The node of claim 1, wherein the control module is configured to perform an assisted driving operation or an autonomous vehicle operation based on the updated data.

3. The node of claim 1, wherein:
the edge computing module is configured to extract a second primitive from the resultant data; and
the second primitive is at a higher level than the one or more primitives.

4. The node of claim 3, wherein the edge computing module is configured to generate the first table of data corresponding to the second primitive.

5. The node of claim 1, wherein the edge computing module is configured to perform an authorization process with the cloud-based server to authorize the node to upload the changed primitive and corresponding raw data to the cloud-based server.

6. The node of claim 1, wherein the edge computing module is configured to receive (i) a verification notice from the cloud-based server indicating whether the changed primitive and corresponding raw data has been verified with a plurality of other detected changed primitives and raw data provided to the cloud-based server from one or more sources other than the node, and (ii) the updated data from the cloud-based server and associated with the changed primitive.

7. The node of claim 6, wherein the edge computing module is configured to update the local table based on the updated data when the changed primitive is verified by the cloud-based server.

8. The node of claim 1, wherein:
the node is a vehicle; and
the control module controls a plurality of actuators of the vehicle based on the updated data.

9. A system comprising:
the node of claim 1, wherein the node is a first node; and
the cloud-based server comprising
a changed primitive collection module configured to receive an update notification message from the edge computing module, wherein the update notification message indicates that the changed primitive has been detected;
an authentication module configured to determine whether the first node is authorized to update map data;
an object extraction and scene segmentation module configured to (i) receive the changed primitive and the raw data when the first node is authorized to update the map data, and (ii) perform object extraction and scene segmentation;
a verification module configured to (i) correlate at least one of the changed primitive or the raw data with changed primitives and corresponding raw data of other nodes, and (ii) based on whether a plurality of nodes are reporting a same map segment change, verify the changed primitive of the first node is accurate, wherein the plurality of nodes include the first node and the other nodes; and
a map update module configured to update the master database based on the changed primitive of the first node.

10. A cloud-based server comprising:
a memory configured to store a master database;
a collection module configured to receive an update notification message from an edge computing module of a first node or an edge computing device separate from the first node, wherein the update notification message indicates a changed primitive has been detected, and wherein the changed primitive refers to an aspect of an environment of the node;
an authentication module configured to determine whether the first node or the edge computing device is authorized to update map data;
an object extraction and scene segmentation module configured to (i) receive the changed primitive and corresponding raw data when the first node or edge gateway device is authorized to update the map data, and (ii) perform object extraction and scene segmentation;
a verification module configured to (i) correlate at least one of the changed primitive or the raw data with changed primitives and corresponding raw data of other nodes, and (ii) based on whether a plurality of nodes are reporting a same map segment change, verify the changed primitive of the first node or edge gateway device is accurate, wherein the plurality of nodes include the first node and the other nodes; and
a map update module configured to update the master database based on the changed primitive of the first node or edge gateway device.

11. The cloud-based server of claim 10, wherein the collection module is configured to receive the changed primitive and corresponding raw data from an edge computing module of the first node or the edge gateway device.

12. The cloud-based server of claim 10, wherein the map update module is configured to generate updated data based on the changed primitive of the first node or edge gateway device and transmit the updated data to the first node to update a local database at the first node and as a result alter operation of the first node.

13. The cloud-based server of claim 10, wherein the map update module is configured to generate updated data based on the changed primitive of the first node or edge gateway device and transmit the updated data to the edge gateway device to update a local database at the edge gateway device.

14. The cloud-based server of claim 10, wherein the verification module is configured to (i) determine a number of map update notifications corresponding to the same map segment that have been received, and (ii) if the number of map update notifications is greater than or equal to a predetermined number, then verify the changed primitive of the first node or edge gateway device.

15. The cloud-based server of claim 10, wherein the verification module is configured to (i) determine a number of map update notifications corresponding to the same map segment that have been received for a same date, and (ii) if the number of map update notifications is greater than or equal to a predetermined number for the same date, then verify the changed primitive of the first node or edge gateway device.

16. The cloud-based server of claim 10, wherein the verification module is configured to (i) randomly select a predetermined number of the primitive changes for the same map segment; and (ii) correlate the randomly selected primitive changes for the same map segment with data in the master database to verify the changed primitive and check accuracy of the changed primitive.

17. An edge gateway device comprising:
a transceiver configured to receive one or more primitives from a node, wherein the one or more primitives refer to an aspect of an environment of the node;
a memory configured to store a local table; and
an edge computing module comprising
a data compatibility module configured to generate a first table of data corresponding to the one or more primitives and compatible with a master table of a master database at a cloud-based server,
a difference detection module configured to compare the first table to the local table to detect a changed primitive,
an upload module configured to upload the changed primitive and raw data corresponding to the changed primitive to the cloud-based server, and
a map update module configured to receive updated data based on the changed primitive from the cloud-based server and update the local table based on the updated data.

18. The edge gateway device of claim 17, wherein the map update module is configured to transmit the updated data to the node to alter operation of the node based on the updated data.

19. The edge gateway device of claim 17, wherein the edge computing module is configured to perform an authorization process with the cloud-based server to authorize the edge gateway device to upload the changed primitive and corresponding raw data to the cloud-based server.

20. The edge gateway device of claim 17, wherein the edge computing module is configured to (i) receive a verification notice from the cloud-based server indicating whether the changed primitive and corresponding raw data has been verified with a plurality of other detected changed primitives and raw data provided to the cloud-based server from one or more sources other than the node, and (ii) receive the updated data from the cloud-based server and associated with the changed primitive, and (iii) update the local table based on the updated data when the changed primitive is verified by the cloud-based server.
